(19) United States
(12) Patent Application Publication
(10) Pub. No.: US 2013/0141463 A1
(43) Pub. Date: Jun. 6, 2013

(54) COMBINED INTERACTIVE MAP AND LIST VIEW

(71) Applicants: Donald A. Barnett, Monroe, WA (US); Tim Wantland, Bellevue, WA (US); Hoon Kong, Seattle, WA (US); Lutz Gerhard, Seattle, WA (US); Michael Bray, Kirkland, WA (US)

(72) Inventors: Donald A. Barnett, Monroe, WA (US); Tim Wantland, Bellevue, WA (US); Hoon Kong, Seattle, WA (US); Lutz Gerhard, Seattle, WA (US); Michael Bray, Kirkland, WA (US)

(73) Assignee: MICROSOFT CORPORATION, Redmond, WA (US)

(21) Appl. No.: 13/311,895

(22) Filed: Dec. 6, 2011

(51) Int. Cl. G09G 5/377

(52) U.S. Cl. 345/636

(57) ABSTRACT

A simultaneously interactive map display and textual listing is presented where both are simultaneously displayed on a display device. The display area of the display device is divided between the map display and the textual listing with one of them receiving a greater proportion than the other. User input directed to the one receiving the greater proportion can be responded to in a traditional manner, while user input directed to the one receiving the lesser proportion can cause a transition whereby the display area is re-proportioned and, with such re-proportioning, the user input can also be responded to in a traditional manner. Additionally, user selections in the textual listing can be simultaneously reflected in the map display, and vice versa, irrespective of which has the greater proportion of the display area. Optionally, a re-proportioning transition can be triggered by such user selections.

### BACKGROUND

To aid in locating relevant information among the ever increasing amount of information available to computing devices via network communications, search engines were developed whereby a user could enter a search query and receive, in response, identifications of collections of data comprising information relevant to that search query. But while search engines were originally developed to aid in the identification of collections of data that comprised information for which a user was searching, they have evolved to now be capable of providing, to users, information regarding, not only collections of data, but also physical entities. For example, modern search engines can provide the addresses and phone numbers of retail establishments and service providers that can be relevant to a user's search query. Similarly, modern search engines can provide other information regarding physical entities that may be relevant to a user's search query such as, for example, mass transit timetables, automotive traffic information, real-time image feeds, and other like information.

When providing location information, such as the addresses and telephone numbers of retail establishments and service providers that are found to be relevant to a user's search query, modern search engines typically provide such information both in textual form and also as locations on a graphical map. Most computing devices can have, depending upon their hardware and software configurations, a theoretically limitless display area within which to display such information to a user. Consequently, on such computing devices, search engines can provide a textual listing of retail establishments, service providers and other entity locations, and can also provide a graphical map comprising the locations of those retail establishments, service providers and other entities, in a sufficiently large format to enable the user to, at a glance, obtain most of the information for which they seek.

Unfortunately, mobile computing devices typically comprise inherent limitations in so far as display area is concerned. In particular, in order to maintain a mobile form factor, which can be transported by a user without an undue burden, most modern mobile computing devices typically comprise displays that are only a few inches in height and width. Thus, even if such displays were to be of very high resolution, their physical size limitations, coupled with the limitations inherent in human eyesight and the human's ability to perceive small details, limit the amount of graphical information that can be displayed on such displays and meaningfully conveyed to a human user. Therefore, when executing on a mobile computing device, the interface presented by modern search engines typically comprises either a textual listing of locations that were found to be relevant to a user search query, with a small, non-interactive, map, or it comprises a dedicated map display in which individual locations, and their respective information, are displayed, not as a list that can be browsed by a user, but rather as individual collections of textual data each floating over the displayed map proximate to the location, on the displayed map, of their individual, respective entities.

### SUMMARY

In one embodiment, the presentation of physical entity information, including the name, address and contact information of such a physical entity, can comprise both a textual listing of relevant physical entities and a map display illustrating the locations of the listed physical entities, where dominance can be provided to either the textual listing or the map display such that one of them comprises a greater proportion of the screen area, and where both can be simultaneously interactive.

In another embodiment, interactivity with whichever one of the textual listing or the map display comprises the greater proportion of the screen area can proceed in a traditional manner while interactivity with the other one that comprises the lesser proportion of screen area can cause a dynamic transition such that that other one, in responding to the user's input, increases its proportion of screen area.

In a further embodiment, selections of a specific one of the physical entities, from among the textual listing thereof, can result in the map display being redrawn to show, as selected, a location indicator on the map display corresponding to the location of the physical entity that was selected in the textual listing. Similarly, selections of a specific location indicator on the map display can result in the textual listing being regenerated to show, as selected, the textual listing corresponding to the physical entity whose location was selected in the map display. Such interactivity between the map display in the textual listing is independent of whichever one of them has the greater proportion of screen area assigned to it and the proportion of screen area can either remain as it was previously, except with the map display and textual listing being refreshed to accommodate the user selection, or the proportion of screen area can change depending upon which one of the textual listing or the map display received the user's selection input.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a diagram of an exemplary system for providing a simultaneously interactive map and textual listing;

FIG. 2 is a block diagram of an exemplary simultaneous interactivity with both a map and a textual listing;

FIG. 3 is an exemplary flow diagram of a simultaneously interactive map and textual listing; and

FIG. 4 is a block diagram of an exemplary computing device for providing a simultaneously interactive map and textual listing.

### DETAILED DESCRIPTION

The following description relates to a simultaneously interactive map display and textual listing, both of which are simultaneously displayed on a display device whose physical size introduces practical limitations on the quantity of information that can be simultaneously presented. The display area of the display device can be divided between the map display and the textual listing with one of them receiving a greater proportion of the display area than the other. User input directed to the one receiving the greater proportion of the display area can be responded to in a traditional manner, while user input directed to the one receiving the lesser proportion of the display area can cause a transition whereby the display area is re-proportioned and, with such re-proportioning, the user input can be responded to in a traditional manner. Additionally, user selections in the textual listing can be simultaneously reflected in the map display, and vice versa, irrespective of which has the greater proportion of the display area. Optionally, a re-proportioning transition can be triggered by such user selections.

The techniques described herein focus on the presentation of a map display and a textual listing, where both are simultaneously interactive, within the context of mobile computing devices or other computing devices with similar physical constraints that limit the size of any display devices associated with such computing devices. However, such descriptions are not meant to suggest a limitation of the described techniques to only the display of map and textual data within the context of mobile computing devices. To the contrary, the described techniques are equally applicable to any computing device, including, for example, computing devices directed to users with visual or other disabilities or impairments. Additionally, the techniques described herein focus on the presentation of a map display and a textual listing in a vertical orientation, where one is displayed “on top of” the other. However, such descriptions are not meant to suggest a limitation of the described techniques to only vertically oriented display arrangements of map and textual data. To the contrary, the described techniques are equally applicable to display arrangements, including, for example, a side-by-side display arrangement, a diagonally divided display arrangement and window-in-window display arrangements.

Although not required, the description below will be in the general context of computer-executable instructions, such as program modules, being executed by a computing device. More specifically, the description will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to stand-alone computing devices, as the mechanisms may also be practiced in distributed computing environments where tasks are performed by remote processing devices that are linked through a communications network. In a distributed computing environment, program modules may be located in both local and remote memory storage devices.

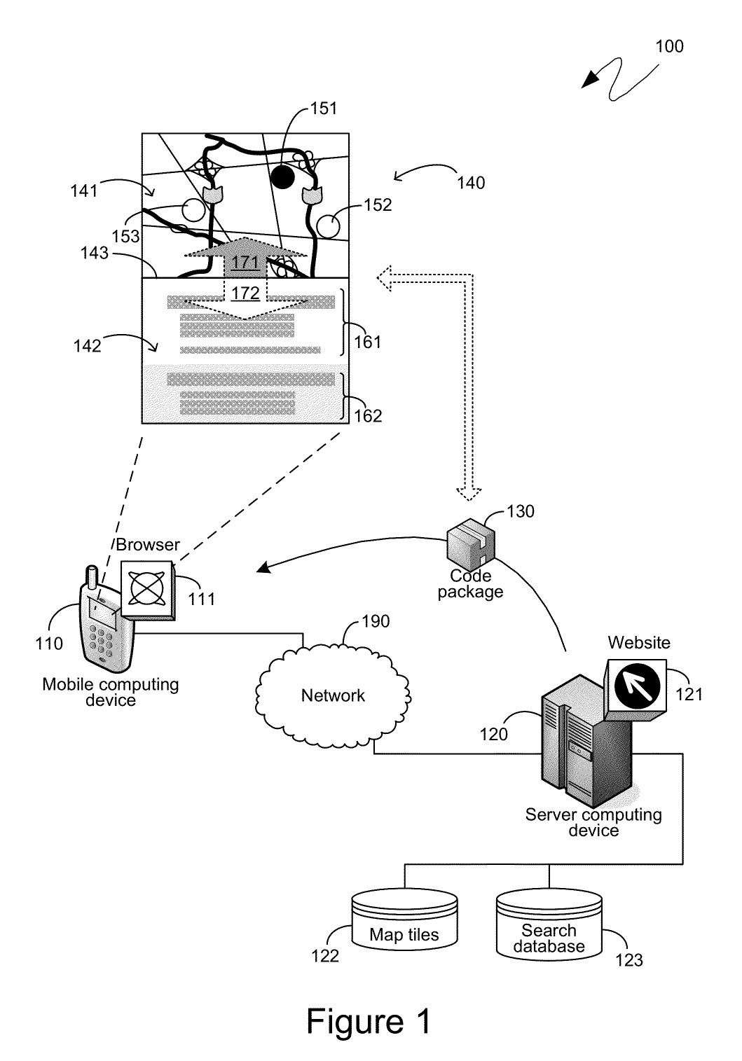

With reference to FIG. 1, an exemplary system 100 is illustrated, providing context for the descriptions below. The exemplary system 100 comprises a mobile computing device 110 on which can execute a browser application program 111 or other like application program that can receive computer-executable instructions and data from across the network 190 to which the mobile computing device 110 can be communicationally coupled. Also communicationally coupled to the network 190 can be one or more server computing devices, such as the server computing device 120, on which can be executing computer-executable instructions for providing a website 121. In one embodiment, the website 121 can be a search engine or other like resource for providing data relevant to a user's query. The server computing device 120 can be communicationally coupled to one or more databases or other like collections of information including, for example, the map tiles 122 that can be utilized to generate a seamless map display in a manner well known to those skilled in the art, and a search database 123 that can be utilized to identify data relevant to a user's query.

In one embodiment, a user of the mobile computing device 110 can, such as, for example, by using the browser 111, provide a search query, via the network 190, to the website 121 executing on the server computing device 120. Such a search query can, based on the search database 123, be found to be relevant to, or associated with, one or more physical entities such as, for example, retail establishments, such as grocery stores, department stores, electronics stores, and the like, service providers, such as plumbers, doctors, roofers, and the like, or other physical entities, including individual people. Typically, such physical entities are identified by a mailing address at which they can be physically located. Consequently, in providing information that is responsive to the user's query, response of physical entities can be identified not only by a textual representation of their mailing address and other like data, such as, for example, a phone number, but they can also be identified by indicating, on a graphical map display, the location corresponding to the mailing address or other like location of the responsive physical entity.

The exemplary display 140 illustrates one exemplary mechanism by which information regarding physical entities can be provided to a user. A user, such as of the mobile computing device 110, can be presented information regarding physical entities by causing the display device of the mobile computing device 110 to render the display 140, such as by aligning appropriate pixels in a Liquid Crystal Display, stimulating appropriate quanta of an Organic Light Emitting Display (OLED), or other like actions to cause the display device to generate a physical image corresponding to the display 140. In the specific embodiment illustrated by the system 100 of FIG. 1, the exemplary display 140 comprises a map display 141 and a textual listing 142 that are oriented in a vertical manner, with the map display 141 being oriented above the textual listing 142. As indicated previously, however, such a vertical orientation is merely exemplary and other orientations, including diagonal orientations, side-by-side orientations, and window-in-window orientations, are equally applicable and implementable by the mechanisms described below. Although not specifically illustrated by the system 100 of FIG. 1, it is contemplated, due to the limited physical size of the display device of the mobile computing device 110, that the display 140 represents all of the display area of the display device of the mobile computing device 110. Nevertheless, in other embodiments, the display 140 can represent merely a portion of the information displayed on the display device of the mobile computing device 110, such as, for example, by being a window that is displayed along with other windows by the mobile computing device 110 on its display device.

As illustrated by the system 100 of FIG. 1, in one embodiment, the map display 141 can illustrate the locations of physical entities via location indicators 151, 152 and 153. For purposes of illustration, the location indicator 151 is illustrated in a different shading than the location indicators 152 and 153 to indicate that it is “selected”. Similarly, the textual listing 142 can comprise textual listings of data relevant to the physical entities such as, for example, the name of the physical entity, its mailing address, its telephone number, its website, comments, descriptions or reviews associated with the physical entity, and other like textual information. The textual listings 142 are shown in the exemplary system 100 of FIG. 1 as comprising text 161 regarding one physical entity and text 162 regarding another, different, physical entity. The text 161 is illustrated as having a differently shaded background than the text 162 to illustrate that the text 161 is associated with a “selected” physical entity. For example, the text 161 can correspond to the physical entity whose location is indicated by the selected location indicator 151.

In one embodiment, both the map display 141 and the textual listing 142 can be simultaneously interactive in that they can both respond to user input directed to them. However, due to the typically limited size of the display device of the mobile computing device 110, the proportion of the display 140 that is directed to either the map display 141 or the textual listing 142 can change. For example, the map display 141 can, initially, be assigned a greater proportion of the display 140. Subsequently, were a user to direct input to the textual listing 142, the textual listing could respond to that user input and, simultaneously, the proportion of the display 140 assigned to the textual listing 142 could increase and the proportion of the display 140 assigned to the map display 141 could decrease. Such a change in the proportion of the display 140 is illustrated by the arrow 171 indicating that the divider 143 between the map display 141 and the textual listing 142 can, graphically, move, thereby allocating a greater proportion of the display 140 to the textual listing 142, and a lesser proportion of the display 140 to the map display 141. As another example, the textual listing 142 can, initially, be assigned the greater proportion of the display 140, and were a user to direct input to the map display 141, the proportion of the display 140 assigned to the map display 141 can increase while, simultaneously, the map display 141 can respond to the user's input. Such a change in the proportion of the display 140 is illustrated by the arrow 172 indicating that divider 143 between the map display 141 and the textual listing 142 can, graphically, move, thereby allocating a greater proportion of the display 140 to the map display 141, and a lesser proportion of the display 140 to the textual listing 142.

The simultaneous interactivity provided by both the map display 141 and the textual listing 142, as well as the dynamic reallocation of the proportions of each of the map display 141 and the textual listing 142, within the display 140, can be controlled by computer-executable instructions that can be executed by the browser 111 that is executing on the mobile computing device 110. In one embodiment, such computer-executable instructions can be provided to the browser 111 from the website 121, such as in the form of a code package 130. In such an embodiment, the code package 130 can comprise computer-executable instructions that can be executed by the browser 111, such as, for example, browser-executable scripts or browser-parseable instructions. In an alternative embodiment, the code package 130 can be provided to an operating system of the mobile computing device 110 and can execute on the mobile computing device 110 directly, and not as part of the browser 111.

The code package 130 can comprise, in one embodiment, a set of computer-executable instructions that can provide the map display 141 and respond to user input directed to the map display 141, thereby making the map display 141 interactive, instead of computer-executable instructions that can provide the textual listing 142 and respond to user input directed to the textual listing 142, thereby making the textual listing 142 interactive, and a set of computer-executable instructions that can detect user input directed to one of the map display 141 and the textual listing 142, whichever is assigned the lesser proportion of the display 140 and can, in response, cause the divider 143 to move, thereby providing a greater proportion of the display 140 to whichever one of the map display 141 or the textual listing 142 the user input was directed to. For example, if the map display 141 was assigned the greater proportion of the display 140, and user input directed to the map display 141 can be received by the set of computer-executable instructions that generated the map display 141 and that set of computer-executable instructions can respond appropriately, such as, for example, by zooming the map in or out or translating the map along the direction of the user's input. Similarly, if the textual listing 142 was assigned the greater proportion of the display 140, and user input was directed to that textual listing 142, then such user input can be received by the set of computer-executable instructions that generated the textual listing 142 and that set of computer-executable instructions can respond appropriately, such as, for example, by scrolling the textual listing up or down. However, in one embodiment, if the map display 141 was assigned the greater proportion of the display 140, and user input was directed to the textual listing 142, the set of computer-executable instructions directed to the proportioning of the display 140 can, initially, receive such computer-executable instructions and, in response, can cause a greater proportion of the display 140 to be assigned the textual listing 142. That set of computer-executable instructions can, in addition, pass that user input onto the set of computer-executable instructions responsible for the textual listing 142 informing the computer-executable instructions responsible for the textual listing 142 of both the users input and of the increase in display area now being accorded to the textual listing 142. An analogous operation could be performed if the textual listing 142 was assigned the greater proportion of the display 140 and the user input was directed to the map display 141.

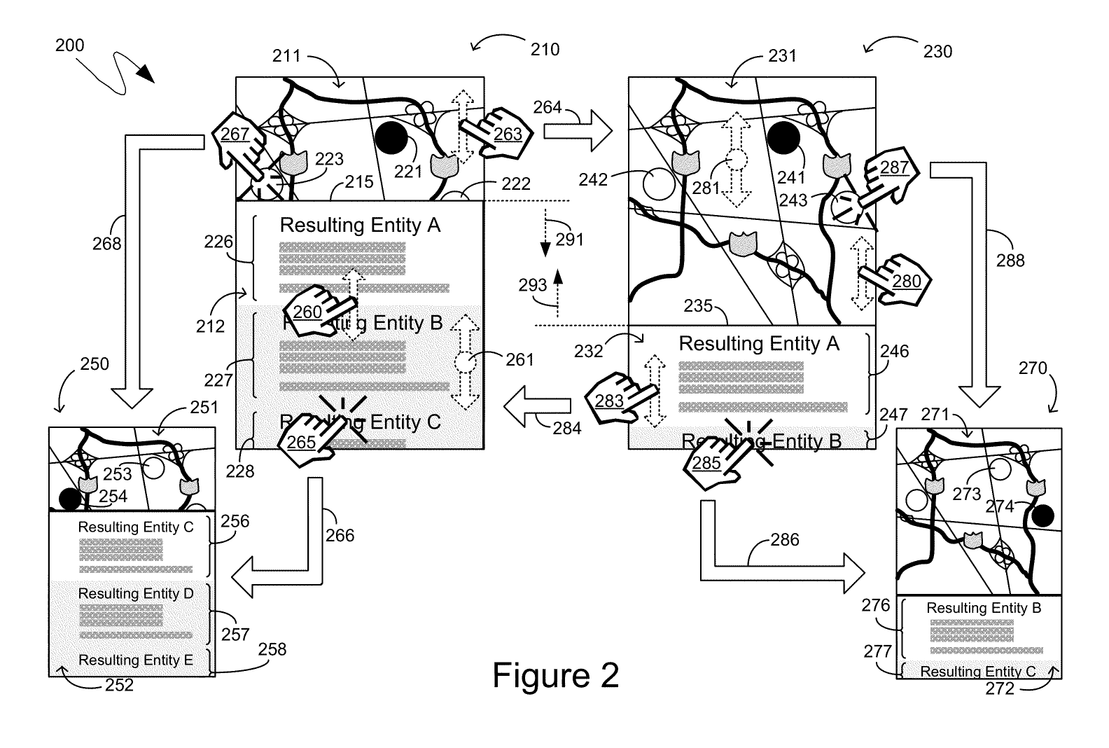

Turning to FIG. 2, the system 200 shown therein illustrates an exemplary set of simultaneous interactivity provided by the combined map and list view. In particular, the display 210 illustrates an exemplary situation in which the map display 211 is assigned a lesser proportion of the display 210 and the textual listing 212 is assigned a greater proportion of the display 210. In such a situation, should the user direct input to the textual listing 212, such as is illustrated by the user input 260, the textual listing 212 can respond accordingly, as illustrated by the actions 261. For example, if the user input 260 was to scroll the textual listing 212 up or down, then, as illustrated by the actions 261, the textual listing 212 can, appropriately, scroll up or down.

However, if, instead of directing input to the textual listing 212, the user instead directed input to the map display 211, as illustrated by the user input 263, such input could cause a transition between the display 210 and the display 230, as illustrated by the arrow 264. In one embodiment, such a transition can occur with the divider 215 moving down to become the divider 235, as illustrated by the arrow 291. Subsequently, as the display transitions from the display 210 to the display 230 the map display 231 in the display 230 can respond to the user input 263, as indicated by the action 281. Thus, for example, if the user input 263 was to scroll the map up or down, then, in addition to transitioning to the display 230, whereby the map display 231 consumes a greater proportion of the display 230 than the map display 211 data of the display 210, the map display 231 can also respond to the user input 263, as illustrated by the actions of 281, such as by moving the map displayed in the map display 231 analogously up or down.

In a similar manner, if the map and list display was in the form of the display 230, where the map display 231 comprises a greater proportion of the display 230 then the textual listing 232, and user input was directed to the map display 231, such as is illustrated by the user input 280, then the map display 231 can respond to such user input 280, such as is illustrated by the actions 281. Thus, for example, if the user input 280 was a pinching input, then the map display 231 can respond by zooming the map out, which can be represented by the actions 281. Conversely, if user input, such as the user input 283, were directed to the textual listing 232, than the display can transition from the display 230 to the display 210, as illustrated by the arrow 284. Such a transition can occur by sliding the divider 235 up to the divider 215, as illustrated by the arrow 293. The user input 283, directed to the textual listing 232, can be responded to by the actions 261 in the textual listing 212, which now comprises a greater proportion of the display 210. Thus, for example, if the user input 283 were a scrolling user input, then the responsive actions 261 can, likewise, scroll the textual listing 212.

As can be seen, by transitioning between a display where the map display comprises a greater proportion, such as the display 230, and a display where the textual listing comprises a greater proportion, such as the display 210, when user input is directed to which ever one of the map display or the textual listing comprises the smaller proportion, simultaneous interactivity with both the map display and the textual listing can be offered even on mobile computing devices whose display devices are too small to display both the map display and the textual listing simultaneously in a sufficient size.

In one embodiment, another example of the interactivity offered simultaneously by both the map display and the textual listing can be the coordination between individual ones of the results listed in the textual listing and the corresponding locations indicated in the map display. For example, in the display 210 the textual listing 212 can comprise three entities, namely the entities 226, 227 and 228, that can, for example, be responsive to a user's search or that can otherwise be relevant to the user of the computing device generating the display 210. The entities 226, 227 and 228, which are displayed in the textual listing 212, can correspond to the locations 221, 222 and 223 that are illustrated in the map display 211. In particular, in the illustrated example shown in FIG. 2, the entity 226 can be located at the location 221, the entity 227 can be located at the location 222, and the entity 228 can be located at the location 223. In one embodiment, a particular one of the entities 226, 227 and 228 can be indicated as being currently selected, and the corresponding location, from among the locations 221, 222 and 223 can also be indicated as being currently selected. For example, in the system 200 of FIG. 2, in the display 210, the entity 226 can be indicated as being currently selected by virtue of a lighter background color than that provided to the entities 227 and 228. Similarly, the corresponding location 221 can, likewise, be indicated as being selected by virtue of its darker color than that assigned to the locations 222 and 223.

Were a user to select a different one of the entities 226, 227 and 228, such as, for example, the entity 228, as illustrated by the user selection input 265, the textual listing 212 can be responsive to such a user selection input 265 and can indicate the entity 228 as being selected. Likewise, simultaneously, the map display 211 can, also, be responsive to such a user selection input 265 and can indicate location 223 as being selected. Thus, as illustrated by the arrow 266, in response to the user selection input 265, of the entity 228 in the textual listing 212, the display 210 can transition to a display 250 where, in the textual listing 252, the entity 228 that was selected by the user selection input 265 in the display 210, now the entity 256, is shown as being selected. Similarly, in the map display 251 of the display 250, the location 254 corresponding to the entity 256 is also shown as being selected. In such a manner, both the textual listing and the map display can be interactive with user selection inputs, such as the user selection input 265. In one embodiment, the textual listing 252 can automatically scroll the listed entities such that the selected entity, namely the entity 256, is at the top and additional entities 257 and 258 that were not shown in the display 210 are now shown. Similarly, in one embodiment, the map display 251 could, likewise, reorient itself such that the selected location 254 was now in the center of the map display 251 although, for illustrative simplicity, such is not shown by the system 200 of FIG. 2.

In one embodiment, a user input 267 that can be directed to the map display 211 of the display 210 can, likewise, result in the transition from the display 210 to the display 250, as illustrated by the arrow 268. For example, as shown in the system 200 of FIG. 2, a user input 267 can select the location 223 that can correspond with the entity 228. As a result of such a user selection, in one embodiment, as illustrated by the arrow 268, the display 210 can transition to the display 250 and the location 254, in the display 250, can be indicated as being selected, where the location 254 corresponds to the location 223 that was displayed in the display 210 and to which the user input 267 was directed. Similarly, the textual listing 252 can update to show the corresponding entity 256 as being selected.

In the embodiment described above, a user selection directed to the map display 211 can result in a display 250 in which the map display 251 still maintains a smaller proportion of the display 250. In an alternative embodiment, user selection directed to the map display 211 can result in the display analogous to display 230, in which the map display 231 increases to comprise a greater proportion of the display 230.

User selections in either the textual listing 232 or the map display 231 can operate in a similar manner within the context of the display 230 as they did within the context of the display 210, which was described in detail above. In particular, the display 230, while having a map display 231 that comprises a larger proportion of the display 230 then the map display 211 did of the display 210, can also have locations indicated in the map display that are equivalent to the locations 221, 222 and 223 described above. In particular, the locations 241 242 and 243 in the map display 231 can correspond to the locations 221, 222 and 223 in the map display 211. Similarly, the textual listing 232, in the display 230, can comprise entities that are equivalent to the entities of the textual listing 212, in the display 210. In particular, the entities 246 and 247 in the textual listing 232 can correspond to the entities 226 and 227 in the textual listing 212.

Thus, within the context of the display 230, if a user were to select the location 243, as indicated by the user selection input 287, then the display 230 can transition to the display 270, as illustrated by the arrow 288. In the display 270, the map display 271 can still comprise a greater proportion, and the textual listing 272 can comprise a lesser portion. However, in the display 270 the location 273, corresponding to the location 241 in the display 230, can be indicated as “not selected” and the location 274, corresponding to the location 243 in the display 230 can be indicated as “selected” in response to the user selection input 287. As indicated previously, in one embodiment, the map display 271 can center itself on the selected location 274, although such is not shown in FIG. 2 in order to maintain illustrative simplicity. In addition, the textual listing 272 can be updated to show the entity 276, corresponding with the location 274, as being selected. Other entities, such as the entity 277, can remain unselected, as indicated by, for example, the background shading. As with the map display 271, the textual listing 272 can center itself on the selected entity 276 by, for example, scrolling such that the selected entity 276 is at the top of the textual listing 272 that is displayed within the display 270.

If a user were to direct selection input 285 to the entity 247 shown in the textual listing 232, then, in one embodiment, the display 230 can transition to the display 270, as illustrated by the arrow 286, even though the user selection input 285 was directed to a portion of the display 230, namely the textual listing 232, that does not comprise a greater proportion of the display 230. Selection of the entity 247 can, like selection of the location 243, result in display 270 where the selected entity, namely the entity 276 in the textual listing 272 of the display 270, be shown is being selected and, correspondingly, its location 274 can also be shown as being selected in the map display 271. Again, as indicated previously, in another, alternative, embodiment, the user selection input 285 could, instead, transition to a display such as the display 250 where, because the user selection input 285 was directed to the textual listing 232, the textual listing can be assigned a greater proportion of the display area such as, for example, the textual listing 252 in the display 250.

Comparing the displays 210 and 230 of the system 200 of FIG. 2, it can be seen that, in the display 210, the map display 211 comprises approximately one-third of the display 210 and the textual listing comprises the other two-thirds. Conversely, in the display 230, it is the map display 231 that comprises approximately two-thirds of the display 230 and the textual listing only comprises one-third. Indeed, in one embodiment, such as the embodiment specifically illustrated by the system 200 of FIG. 2, a display can be divided into thirds where one third, such as the top third in the system 200 of FIG. 2, can be assigned to the map display, another third, such as the bottom third in the system 200 of FIG. 2, can be assigned to the textual listing, and the middle third can act as a transition area that can transition between being part of the map display, such as when the divider is in the position shown by the divider 235, and being part of the textual listing, such as when the divider is in the position shown by the divider 215. In such an embodiment, capabilities need be provided only to transition the divider across the middle third, such as is illustrated in FIG. 2. However, in other embodiments, the display can be divided into any other fractions, such as quarters, with the middle half being the transition area, or any other like fractional divisions.

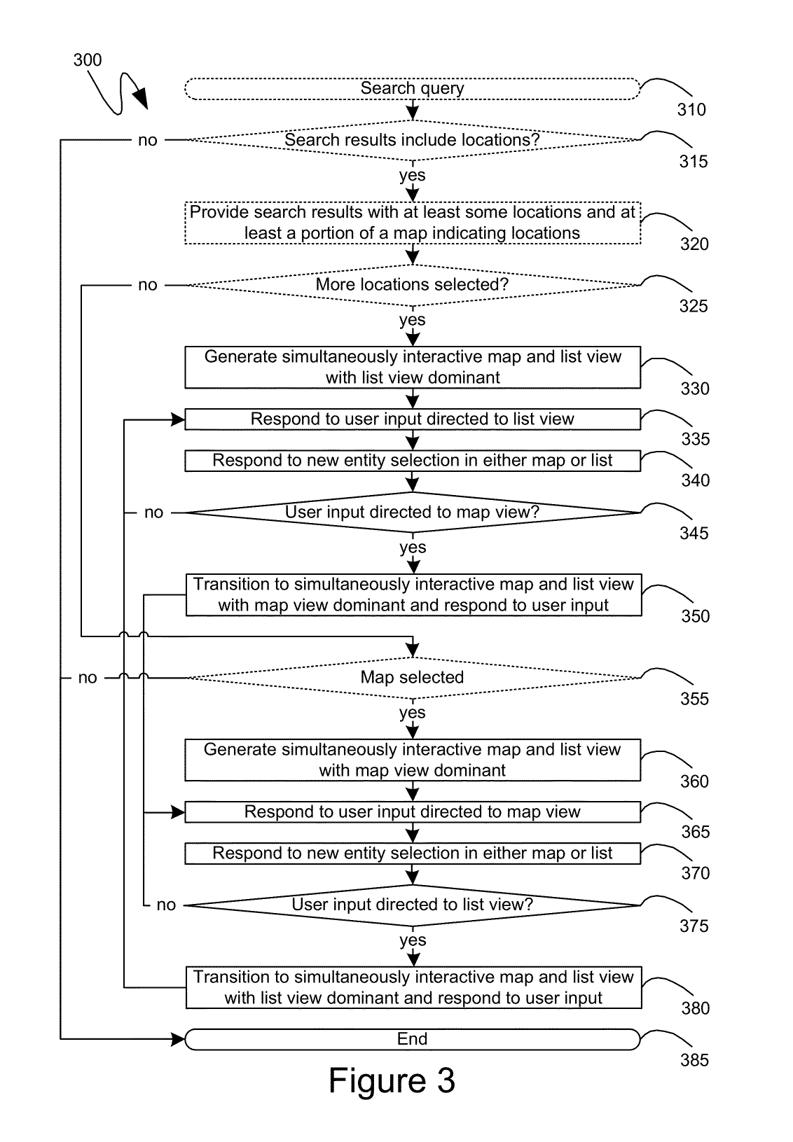

Turning to FIG. 3, the flow diagram 300 shown therein illustrates an exemplary series of steps that can be performed in order to provide for a simultaneously interactive map and list display within a display area of confined size. The steps 310 through 325 and 355 of the flow diagram 300 are illustrated to provide context, but are not required and, as such, they are illustrated via dashed lines. In particular, at step 310, a user's search query can be received. Subsequently, at step 315, a determination can be made as to whether the results that are deemed responsive to the user's search query, that was received at step 310, include physical entities that have defined locations such as, for example, retail establishments, service providers, individuals, or other like entities. If, at step 315, it is determined that no such entities are responsive to the query that was received at step 310, the relevant processing can end at step 385. Alternatively, if, at step 315, it is determined that such entities are responsive to the user's query, then processing can proceed to step 320 where search results responsive to the query that was received at step 310 can be generated and provided to the user. In one embodiment, at step 320, those search results can be provided with at least a portion of a map indicating locations of responsive entities, as well as a listing of at least some of those responsive entities. For ease of reference, such a portion of a map presented with the search results at step 320 will be termed a “map sliver”. Subsequently, at step 325 and, analogously, at step 355 a determination can be made as to whether the user chose to peruse more of such responsive entities and how the user chose to do so. In particular, at step 325, a determination can be made whether the user selected additional location listings to be displayed, and, analogously, at step 355, a determination can be made whether the user selected for additional locations to be displayed on the map display, such as by interacting with the map sliver displayed at step 320. As will be recognized by those skilled in the art, while steps 325 and 355 are illustrated as two distinct steps, one following the other, they can just as easily be implemented as a single decision regarding whether the user selected additional listings, additional map results, or some other selection entirely. If the latter, than the relevant processing can end at step 385, as shown in the flow diagram 300 of FIG. 3. But if the user selected to view additional entity listings, then processing can proceed to step 330 and if the user selected to view additional locations on the map, then processing can proceed to step 360.

As indicated previously, steps 310 through 325 and 355 are illustrated to provide context for the additional steps, such as, for example, to illustrate one mechanism by which the combined and simultaneously interactive map and list view can be initiated. For purposes of the descriptions herein, however, such steps were merely exemplary and other initiating steps would be equally applicable. So long as some indication is received as to whether the map display or the textual listing is to receive the greater proportion of the display area, then processing can proceed with either step 330, if the textual listing is to receive the greater proportion of the display area initially, or step 360, if the map display is to receive the greater proportion of the display area initially.

At step 330, a simultaneously interactive map display and textual listing can be generated on the display, with the area of the display dedicated to the textual listing being greater than the area of the display dedicated to the map display. Subsequently, at step 335, user input directed to the textual listing can be responded to in the traditional manner. For example, user input scrolling the textual listing up or down can result in the textual listing being appropriately scroll up or down. At step 340, should the user select a new location, both the map display and the textual listing can be appropriately updated, such as in the manner described in detail above. Although step 340 indicates that such an updating of the map display and the textual listing can occur irrespective of whether the user's selection of a new entity was directed to the textual listing or the map display, in another embodiment, as described in detail above, if, at step 340, the user's selection of another entity was directed to the textual listing, then the map display and the textual listing can be appropriately updated, but if the user's selection of another entity was directed to the map display then, in such another embodiment, processing could transition to steps 365 through 380 where the map display comprises a greater proportion of the display area while also updating the map display in textual listing in accordance with the user's selection.

At step 345, a determination can be made as to whether the user directed input to the map display. If the user has not directed any user input to the map display, then processing can return to the performance of steps 335 and 340, as already described. Conversely, if, at step 345, user input to the map display is detected then, at step 350, processing can proceed to transition to a simultaneously interactive map and list view where the map display, instead of the textual listing, comprises a greater proportion of the display area. Subsequently, processing can continue with step 365 which will be described in detail below.

If, it was determined that the map display should, initially, comprise a greater proportion of the display area, then processing, instead of commencing at step 330, can instead commence at step 360 where simultaneously interactive map and list could be generated with the map display comprising a greater proportion of the display area. Subsequently, at step 365, user input directed to the map display can be responded to in the traditional manner. For example, user input zooming the map in or out can result in the map display being appropriately zoomed in or out. At step 370, should the user select a new location, both the map display and the textual listing can be appropriately updated, such as in the manner described in detail above. Although step 370 indicates that such an updating of the map display and the textual listing can occur irrespective of whether the user's selection of a new entity was directed to the textual listing or the map display, in another embodiment, as described in detail above, if, at step 370, the user's selection of another entity was directed to the map display, then the map display and the textual listing can be appropriately updated, but if the user's selection of another entity was directed to the textual listing then, in such another embodiment, processing could transition to steps 335 through 350, described in detail above, where the textual listing comprises a greater proportion of the display area while also updating the map display in textual listing in accordance with the user's selection.

At step 375, a determination can be made as to whether the user directed input to the textual listing. If the user has not directed any user input to the textual listing, then processing can return to the performance of steps 365 and 370, as already described. Conversely, if, at step 375, user input to the map display is detected then, at step 380, a transition to a simultaneously interactive map and list view where the textual listing, instead of the map display, comprises a greater proportion of the display area. Subsequently, processing can continue with step 335, which was described in detail above.

In one embodiment, although not specifically enumerated in the flow diagram 300 of FIG. 3, the transitions 350 and 380 can occur in a graphically dynamic manner such that the transitions appear smooth, visually, to the user. For example, and referencing back to FIG. 2, the transition at step 350 can be performed by graphically moving the divider 215 down to the divider 235, as illustrated by the arrow 291. At each incremental move of the divider 215, as it progresses down to the divider 235 in an animated fashion, the additional display area provided to the map display can be utilized by the map display to display a greater portion of the map, while the incrementally less display area taken from the textual listing can be appropriately updated to now comprise less textual listings. As a result, the user can perceive a graphically seamless transition of the divider 215 down to the divider 235 with the map display seamlessly growing and the textual listing seamlessly shrinking In an analogous manner, the transition at step 380 can be performed by graphically moving the divider 235 up to the divider 215, as illustrated by the arrow 293. Again, at each incremental move of the divider 235, as it progresses up to the divider 215 in an animated fashion, the display area taken from the map display can cause the map to display an incrementally smaller portion of the map, and the additional display area provided to the textual listing can cause the textual listing to display additional entities from the bottom of the textual listing, as illustrated by the system 200 of FIG. 2.

In one embodiment, as the display area provided to either the map display or the textual listing increases or decreases, the added or subtracted area can affect a fixed portion of the map display and textual listing. For example, as illustrated by the system 200, as the display 210 transitions to the display 230, and the textual listing 212 transitions to the textual listing 232, the space subtracted from the textual listing 212 can be subtracted from the bottom such that, even though the divider 215 is progressing down to the divider 235, the relative position of the first entity in the textual listing, namely the entity 226 and analogous entity 246, can remain constant with respect to the divider 215 transitioning down to the divider 235. The converse can be true in the reverse situation where the display 230 transitions to display 210.

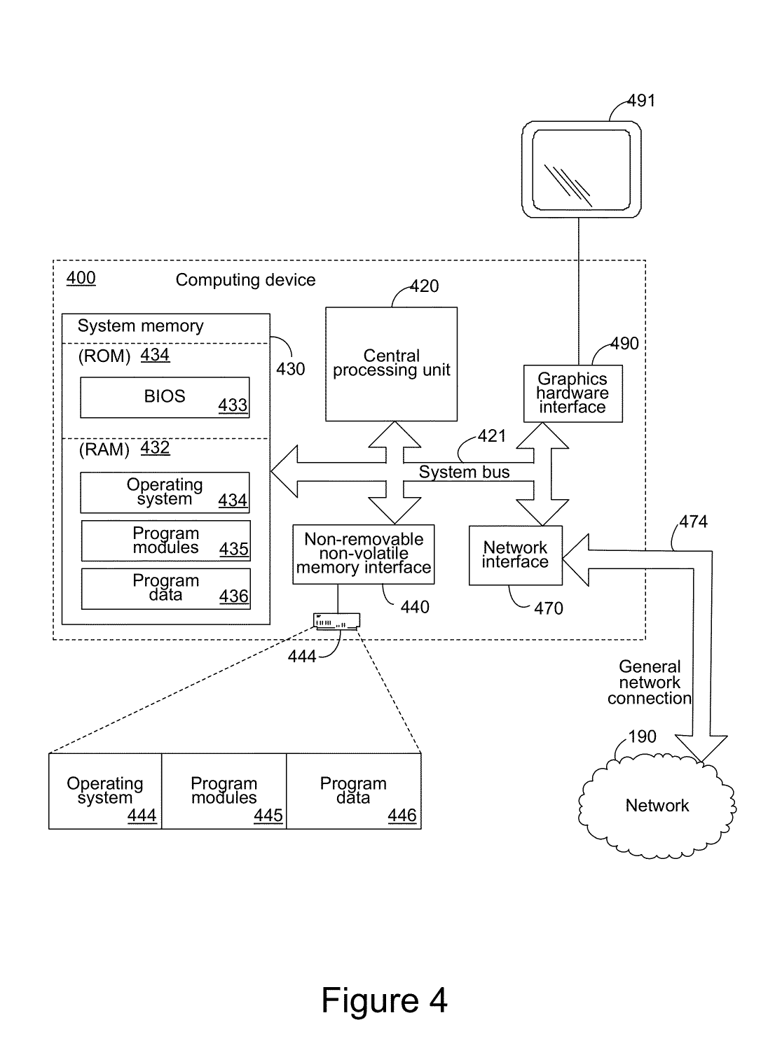

Turning to FIG. 4, an exemplary computing device 400 is shown that can be the mobile computing device 110 that was illustrated in FIG. 1, and can also represent the server computing device 120, also illustrated in FIG. 1. The exemplary computing device 400 can include, but is not limited to, one or more central processing units (CPUs) 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include the Peripheral Component Interconnect (PCI) bus and various higher speed versions thereof, the Industry Standard Architecture (ISA) bus and Enhanced ISA (EISA) bus, the Micro Channel Architecture (MCA) bus, and the Video Electronics Standards Associate (VESA) bus. The computing device 400 can optionally include graphics hardware, including, but not limited to, a graphics hardware interface 490 and a display device 491.

The computing device 400 also typically includes computer readable media, which can include any available media that can be accessed by computing device 400 and includes both volatile and nonvolatile media and removable and non-removable media. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 400. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 430 includes computer storage media in the form of volatile and/or nonvolatile memory such as read only memory (ROM) 434 and random access memory (RAM) 432. A basic input/output system 433 (BIOS), containing the basic routines that help to transfer information between elements within computing device 400, such as during start-up, is typically stored in ROM 434. RAM 432 typically contains data and/or program modules that are immediately accessible to and/or presently being operated on by processing unit 420. By way of example, and not limitation, FIG. 4 illustrates operating system 434, other program modules 435, and program data 436.

The computing device 400 may also include other removable/non-removable, volatile/nonvolatile computer storage media. By way of example only, FIG. 4 illustrates a hard disk drive 444 that reads from or writes to non-removable, nonvolatile magnetic media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 444 is typically connected to the system bus 421 through a non-removable memory interface such as interface 440.

The drives and their associated computer storage media discussed above and illustrated in FIG. 4, provide storage of computer readable instructions, data structures, program modules and other data for the computing device 400. In FIG. 4, for example, hard disk drive 444 is illustrated as storing operating system 444, other program modules 445, and program data 446. Note that these components can either be the same as or different from operating system 434, other program modules 435 and program data 436. Operating system 444, other program modules 445 and program data 446 are given different numbers hereto illustrate that, at a minimum, they are different copies.

Of relevance to the descriptions above, the computing device 400 may operate in a networked environment using logical connections to one or more remote computers. For simplicity of illustration, and in conformance with the exemplary system 100 of FIG. 1, the computing device 400 is shown in FIG. 4 to be connected to the network 190. However, the computing device 400 is not limited to any particular network or networking protocols. The logical connection depicted in FIG. 4 is a general network connection 474 that can be a local area network (LAN), a wide area network (WAN), a web-based or cloud-based network, cellular network or other networks. The computing device 400 is connected to the general network connection 474 through a network interface or adapter 470 which is, in turn, connected to the system bus 421. In a networked environment, program modules depicted relative to the computing device 400, or portions or peripherals thereof, may be stored in the memory of one or more other computing devices that are communicatively coupled to the computing device 400 through the general network connection 474. It will be appreciated that the network connections shown are exemplary and other means of establishing a communications link between computing devices may be used.

As can be seen from the above descriptions, a combined and simultaneously interactive map and list view can be provided within limited display areas. In view of the many possible variations of the subject matter described herein, we claim as our invention all such embodiments as may come within the scope of the following claims and equivalents thereto.

We claim:

1. One or more computer-readable media comprising computer-executable instructions for generating a display of a map and a list, the computer-executable instructions directed to steps comprising:
generating a first display comprising the map, the list, and a divider between the map and the list, the divider dividing the first display into a greater proportion of the first display area and a lesser proportion of the first display area with one of the map or the list being generated in the greater proportion of the first display area and an other of the map or the list being generated in the lesser proportion of the first display area, the map comprising at least one location indicator indicating a location, on the map, of at least one entity whose information is listed in the list;
generating a second display in response to user input directed to the greater proportion of the first display area, the second display comprising an updated map or list, whichever was generated in the greater proportion of the first display area, in accordance with, and responsive to, the user input; and
generating a third display, if the user input was directed to the lesser proportion of the first display area, by moving the divider of the first display to divide the third display into a greater proportion of the third display area that encompasses all of the lesser proportion of the first display area, and to divide the third display into a lesser proportion of the third display area that encompasses a portion of the greater proportion of the first display area, the third display comprising, in the greater proportion of the third display area, an updated version of the map or list, whichever was generated in the lesser proportion of the first display area, in accordance with, and responsive to, the user input.

2. The computer-readable media of claim 1, wherein, if the user input is a user selection input that selects an entity corresponding to a location indicator on the map and corresponding to information in the list, then the computer-executable instructions for generating the second display further comprise computer-executable instructions for indicating the entity's location indicator, on the updated map, as having been selected and indicating the entity's information, in the updated list, as having been selected, and the computer-executable instructions for generating the third display likewise further comprise computer-executable instructions for indicating the entity's location indicator, on the updated map, as having been selected and indicating the entity's information, in the updated list, as having been selected.

3. The computer-readable media of claim 2, wherein the computer-executable instructions for generating the third display do not move the divider if the user input is the user selection input.

4. The computer-readable media of claim 2, wherein the updated map is centered on the entity's location indicator.

5. The computer-readable media of claim 1, wherein the computer-executable instructions for generating the third display comprise computer-executable instructions for incrementally moving the divider in a repeated manner to animate the moving of the divider, and generating an incrementally updated map and an incrementally updated list for each incremental move of the divider, the incrementally updated map and incrementally updated list accommodating changes in display areas resulting from each incremental move of the divider.

6. The computer-readable media of claim 5, wherein the map and the list are oriented vertically with the map above the divider and the list below the divider, and wherein further the computer-executable instructions for generating the incrementally updated list comprise computer-executable instructions for displaying additional list elements below those already displayed by the list when the divider above the list is incrementally moved upwards.

7. The computer-readable media of claim 1, wherein the one of the map or the list being generated in the greater proportion of the first display is selected based on a user's response to a presentation of search results such that, if the user's response to the presentation of search results is directed to a map sliver presented with the search results, then the map is generated in the greater proportion of the first display and if the user's response to the presentation of search results is directed to additional listings, then the list is generated in the greater proportion of the first display.

8. The computer-readable media of claim 1, wherein the computer-executable instructions are executed by a browser application program executing on a mobile computing device.

9. The computer-readable media of claim 1, wherein the map and the list are oriented vertically with the map above the divider and the list below the divider.

10. A method for generating a display of a map and a list comprising the steps of:
generating a first display comprising the map, the list, and a divider between the map and the list, the divider dividing the first display into a greater proportion of the first display area and a lesser proportion of the first display area with one of the map or the list being generated in the greater proportion of the first display area and an other of the map or the list being generated in the lesser proportion of the first display area, the map comprising at least one location indicator indicating a location, on the map, of at least one entity whose information is listed in the list;
generating a second display in response to user input directed to the greater proportion of the first display area, the second display comprising an updated map or list, whichever was generated in the greater proportion of the first display area, in accordance with, and responsive to, the user input; and
generating a third display, if the user input was directed to the lesser proportion of the first display area, by moving the divider of the first display to divide the third display into a greater proportion of the third display area that encompasses all of the lesser proportion of the first display area, and to divide the third display into a lesser proportion of the third display area that encompasses a portion of the greater proportion of the first display area, the third display comprising, in the greater proportion of the third display area, an updated version of the map or list, whichever was generated in the lesser proportion of the first display area, in accordance with, and responsive to, the user input.

11. The method of claim 10, wherein, if the user input is a user selection input that selects an entity corresponding to a location indicator on the map and corresponding to information in the list, then the generating the second display further comprises indicating the entity's location indicator, on the updated map, as having been selected and indicating the entity's information, in the updated list, as having been selected, and the generating the third display likewise further comprises indicating the entity's location indicator, on the updated map, as having been selected and indicating the entity's information, in the updated list, as having been selected.

12. The method of claim 11, wherein the generating the third display comprises leaving the divider unmoved if the user input is the user selection input.

13. The method of claim 11, wherein the updated map is centered on the entity's location indicator.

14. The method of claim 10, wherein the generating the third display comprises incrementally moving the divider in a repeated manner to animate the moving of the divider, and generating an incrementally updated map and an incrementally updated list for each incremental move of the divider, the incrementally updated map and incrementally updated list accommodating changes in display areas resulting from each incremental move of the divider.

15. The method of claim 14, wherein the map and the list are oriented vertically with the map above the divider and the list below the divider, and wherein further the generating the incrementally updated list comprises displaying additional list elements below those already displayed by the list when the divider above the list is incrementally moved upwards.

16. The method of claim 10, wherein the one of the map or the list being generated in the greater proportion of the first display is selected based on a user's response to a presentation of search results such that, if the user's response to the presentation of search results is directed to a map sliver presented with the search results, then the map is generated in the greater proportion of the first display and if the user's response to the presentation of search results is directed to additional listings, then the list is generated in the greater proportion of the first display.

17. The method of claim 10, wherein the method is performed by a browser application program executing on a mobile computing device.

18. The method of claim 10, wherein the map and the list are oriented vertically with the map above the divider and the list below the divider.

19. A user interface providing a simultaneously interactive map and list on a display device of a portable computing device, the user interface comprising:
a first portion on a first side of a divider, the first portion displaying the interactive map;
a second portion on a second side of the divider, the second portion displaying the interactive list; and
the divider, which moves such that, if a user input is directed to either the first portion or the second portion, and the portion to which the user input is directed does not comprise a greater proportion of the user interface than an other portion, then the divider moves such that the portion to which the user input is directed becomes the greater proportion of the user interface after the move;
wherein the interactive map and the interactive list respond to the user input concurrently with the divider moving.

20. The user interface of claim 19, wherein the first portion comprises either one-third or two-thirds of the user interface and the second portion comprises two-thirds of the user interface if the first portion comprises one-third of the user interface and comprises one-third of the user interface if the first portion comprises two-thirds of the user interface, and wherein further the divider moves between dividing the user interface into the first portion comprising one-third of the user interface and the second portion comprising two-thirds of the user interface and the first portion comprising two-thirds of the user interface and the second portion comprising one-third of the user interface.
